(19) United States
(12) Patent Application Publication
(10) Pub. No.: US 2019/0005495 A1
(43) Pub. Date: Jan. 3, 2019

(54) METHOD FOR VERIFYING TRANSACTIONS IN CHIP CARDS

(71) Applicants: Joe Chi CHEN, (US); Andrew Chien CHEN, (US); Louis Chien CHEN, (US)

(72) Inventor: Joe Chi CHEN, Rowland Heights, CA (US)

(21) Appl. No.: 15/641,050

(22) Filed: Jul. 3, 2017

(51) Int. Cl. G06Q 20/40; G06Q 20/34

(52) U.S. Cl. CPC G06Q 20/401; G06Q 20/341

(57) ABSTRACT

The present invention provides a method for verifying transactions in chip cards which effectively protects a chip card from being copied and facilitates transmission of transactional messages or transactional information over open networks. Consequently, personal information of a particular account and data stored in a chip card thereof cannot be obtained by intercepting the transmitted transactional details, effectively protecting the chip card from being copied, and facilitating the transmission of transactional messages or transactional information over open networks.

### BACKGROUND OF THE INVENTION

### a) Field of the Invention

The present invention relates to e-commerce verification technology, and aims to provide a method for verifying transactions in chip cards that protects a chip card from being copied, and facilitates transmission of transactional messages or transactional information over open networks.

### b) Description of the Prior Art

The arrival of credit cards has certainly led the transaction mode in our daily life into the era of electronic transactions. As the credit cards become ever more popularized, they have brought more convenience to the consumers; debit cards and credit cards are now the must-have financial tools in the society nowadays, but at the same time the security problems related to the electronic transactions of credit cards or debit cards also occur frequently.

In comparison to the traditional credit cards with magnetic stripes, the credit cards or debit cards with chips (commonly referred to as chip cards hereafter) have built-in IC (Integrated Circuit) chips, and can have a private key from a management platform (such as an issuing bank, a billing bank and a backend system, ie. an issuing institution) and related verification algorithm stored therein; verification by multiple processes of encryption and decryption has to be accomplished in order to complete a transaction, which has indeed improved the problem of fraudulent use of chip cards.

Generally, the IC chip structure of a chip card mainly includes a mini central unit and EEPROM (Electrically-Erasable Programmable Read-Only Memory); wherein the mini central unit has a RAM (Random Access Memory) for storing the temporary data accessed by the CPU (Central Processing Unit) performing computing and the COS (Card OS) processing data.

On the other hand, the main function of the EEPROM is to provide the user of the chip card with a space for storing data, which includes: A Directory Area for recording data storage location, length and other relevant information, a Secret Area for storing the private key and a Data Area for a user to store data and other data management information.

During normal use of a chip card, the owner of the chip card selects an appropriate card application for making a transaction according to the content or setting of the chip card via a related reading device, and in accordance with the initial information provided by the card, obtains all of the required data for the transaction (for instance, the card number, the issuing bank certification or card certification) in order to perform preliminary verification on the chip card; the reading device, the management platform (the issuing bank) and the backend system (the issuing institution) subsequently verify whether or not a replied message is correct via a closed-off network card and use this as a basis for whether to accept the transaction or not.

However, as the criminal syndicates become ever more coordinated and organized, the criminal activity targeting chip card electronic transactions has shifted from the earlier small-scale theft of chip cards to the large-scale copying and making counterfeit cards nowadays. The existing method for verifying transactions in chip cards has the shortcoming of openly transmitting transactional message or information, and the personal information of a particular account can be obtained by intercepting the transmitted transactional content and then used to make a counterfeit card by decoding the information stored in the chip, and now also encountering the even more serious problem of having counterfeit cards being produced massively by decoding the personal information of accounts using a specific chip under the issuing institution from the chip card manufacturing factory.

### SUMMARY OF THE INVENTION

It is an object of the invention to provide a method for verifying transactions in chip cards that protects a chip card from being copied, and facilitates transmission of transactional messages or transactional information over open networks.

According to the present invention, the method for verifying transactions in chip cards comprises the following steps: (a) creating a mathematical formula and an initial code, wherein a chip card manufacturing factory respectively integrates at least the mathematical formula and the initial code corresponding to the mathematical formula into a chip card to be issued, and the mathematical formula corresponding to each of the chip cards and the initial code corresponding to the mathematical formula are created in a backend system; (b) creating personal information of a cardholder, wherein when each of the chip cards is to be issued, a management platform respectively sends the personal information from an account of the cardholder of the chip card to be issued back to the backend system for authentication, where the backend system respectively determines a corresponding relationship between information stored in the chip card to be issued by the management platform and the personal information of the cardholder; (c) generating a dynamic source and a dynamic identification code, when the issued and activated chip card is to make a transaction, a chip card reading device is used to correspondingly generate a time of the transaction, and the chip card uses at least an accumulated number of transactions and the time of the transaction as the dynamic source for plugging into a mathematical formula thereof and generating a set of dynamic identification code; (d) requesting for authorization, the chip card reading device transmits at least the dynamic source generated from the transaction and the dynamic identification code to the management platform; (e) generating dynamic verification information, wherein the management platform transmits at least a card number of the chip card and the dynamic source generated from the transaction to the backend system, such that the backend system can plug the obtained dynamic source into the mathematical formula corresponding to the card number of the chip card and subsequently generating a set of dynamic verification code; (f) obtaining authorization, wherein the backend system transmits the dynamic verification code back to the management platform, and then the management platform compares the received dynamic verification code with the dynamic identification code, and authorizing the transaction if they match, or rejecting the transaction if not.

By utilizing the described characteristics, the method for verifying transactions in chip cards of the present invention uses a dynamic source generated from a current transaction and a dynamic verification code as a basis for requesting authorization during each transaction, and obtains verification for the authorization by using the backend system to transmit the dynamic verification code in a single direction for the management platform to perform comparison, thus preventing personal information of a particular account and data stored in a chip card thereof from being obtained by intercepting the transmitted transactional content, and effectively protecting the chip card from being copied, facilitating the transmission of transactional messages or transactional information over open networks.

Moreover, in the method for verifying transactions in chip cards of the present invention, the step of creating a mathematical formula and an initial code further comprises respectively integrating at least one mathematical ciphertext into the chip card to be issued; the step of generating a dynamic source and a dynamic identification code further comprises generating a dynamic ciphertext from the mathematical ciphertext and the dynamic source generated from the transaction, and then generating a dynamic number set by integrating the dynamic ciphertext with information randomly inputted by the cardholder in the transaction; the step of requesting for authorization further comprises the chip card reading device transmitting at least the dynamic number set generated from the transaction to the management platform; the step of generating dynamic verification information further comprises the backend system generating a set of dynamic private key by using the obtained dynamic source and the mathematical ciphertext corresponding to the card number of the chip card; the step of obtaining authorization further comprises the backend system transmitting the dynamic private key back to the management platform, such that the management platform can use the dynamic private key to decrypt the dynamic number set, and recover the information randomly inputted by the cardholder in the transaction if the dynamic private key matches with the dynamic ciphertext.

Furthermore, in the method for verifying transactions in chip cards of the present invention, the step of creating a mathematical formula and an initial code further comprises respectively integrating at least two sets of hidden passing phrase into the chip card to be issued; the step of generating a dynamic source and a dynamic identification code further comprises generating a dynamic second-track encryption initial code from the hidden passing phrases, the dynamic source generated from the transaction and the personal information stored in the chip card, and generating a dynamic identification code and multiple sets of dynamic ciphertext from the dynamic second-track encryption initial code, the personal information stored in the chip card and random transactional information randomly inputted in the transaction by mathematical computing through using the two sets of hidden passing phrase; the step of requesting for authorization further comprises the chip card reading device transmitting the card number of the chip card, the dynamic source, the dynamic identification code and the multiple sets of dynamic ciphertext to the management platform; the step of generating dynamic verification information further comprises the management platform transmitting at least the card number of the chip card and the dynamic source to the backend system, such that the backend system can plug the dynamic source into the mathematical formula corresponding to the card number of the chip card, the initial code and any of the hidden passing phrases for generating a dynamic ciphertext decryption public key, and the backend system is set to further encrypt the dynamic ciphertext decryption public key into encrypted public key data by using private key data of the management platform if the dynamic ciphertext decryption public key matches with the dynamic identification code, and then transmit the encrypted public key data to the management platform; the step of obtaining authorization further comprises the management platform recovering the dynamic second-track encryption initial code by further using the private key data thereof to decrypt the encrypted public key data, and then authorizing the transaction if the random transactional information and personal information is obtained after decrypting by utilizing the dynamic ciphertext, or rejecting the transaction if not.

In the method for verifying transactions in chip cards of the present invention, the step of creating a mathematical formula and an initial code can further comprise having the chip card manufacturing factory providing a plurality of first static identification codes for the backend system to respectively identify stored information between each of the chip cards.

In the method for verifying transactions in chip cards of the present invention, the step of creating personal information of a cardholder can further comprise having the backend system generating a plurality of second static identification codes for respectively identifying identities of each of the chips by the backend system and by the management platform.

In the method for verifying transactions in chip cards of the present invention, the step of creating a mathematical formula and an initial code can further comprise having the chip card manufacturing factory providing a plurality of first static identification codes for the backend system to respectively identify stored information between each of the chip cards, and the step of creating personal information of a cardholder can further comprise having the backend system generating a plurality of second static identification codes for respectively identifying identities of each of the chips by the backend system and by the management platform.

The backend system is a network information management computing system created by an issuing institution; the management platform is a network information management computing system created by an issuing bank.

The method for verifying transactions in chip cards disclosed in the present invention uses a dynamic source generated from a current transaction and a dynamic verification code as a basis for requesting authorization, and obtains verification for the authorization by using the backend system to perform comparison in a single direction, thus preventing personal information of a particular account and data stored in a chip card thereof from being obtained by intercepting the transmitted transactional content, and effectively protecting the chip card from being copied, facilitating the transmission of transactional messages or transactional information over open networks. The method can even be widely applied in encrypted transmission of network information, and more particularly can prevent a management platform (an issuing bank) or staff at a chip card manufacturing factory from decoding account information of a specific chip corresponding to a backend system (an issuing institution) and making counterfeit cards on a large scale.

To enable a further understanding of the said objectives and the technological methods of the invention herein, the brief description of the drawings below is followed by the detailed description of the preferred embodiments.

### BRIEF DESCRIPTION OF THE DRAWINGS

FIG. 1 is a basic flowchart showing the method for verifying transactions in chip cards according to the present invention.

FIG. 2 is a schematic view showing a way of transmitting information that may be implemented in the method for verifying transactions in chip cards according to the present invention.

FIG. 3 is a schematic view showing a way of identifying a chip card that may be implemented in the method for verifying transactions in chip cards according to the present invention.

FIG. 4 is a schematic view showing a second way of transmitting information that may be implemented in the method for verifying transactions in chip cards according to the present invention.

FIG. 5 is a schematic view showing a third way of transmitting information that may be implemented in the method for verifying transactions in chip cards according to the present invention.

### DETAILED DESCRIPTION OF THE PREFERRED EMBODIMENTS

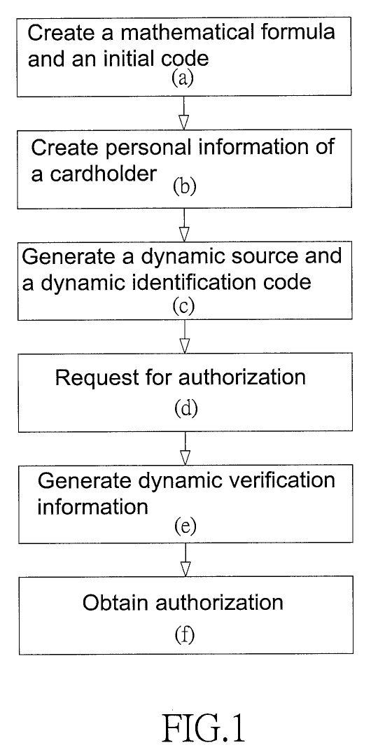

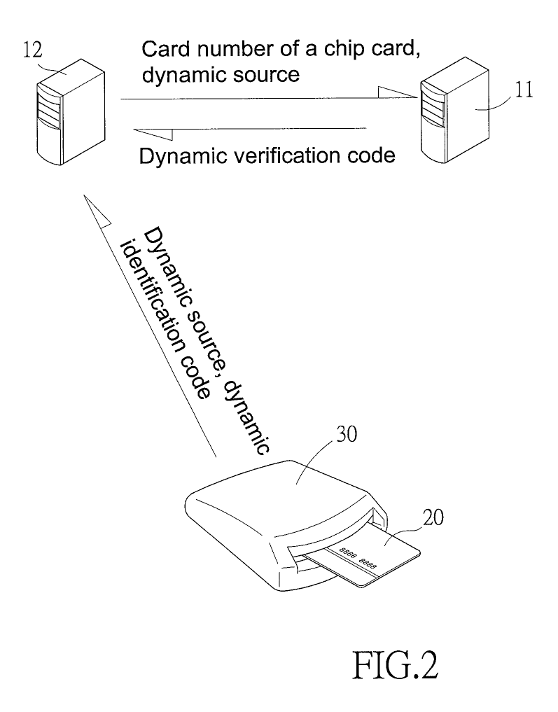

The present invention provides a method for verifying transactions in chip cards that protects a chip card from being copied and facilitates transmission of transactional messages or transactional information over open networks. As indicated in FIGS. 1 and 2, the method for verifying transactions in chip cards according to the present invention fundamentally comprises:

(a) creating a mathematical formula and an initial code, wherein a chip card manufacturing factory 13 respectively integrates at least the mathematical formula and the initial code corresponding to the mathematical formula into a chip card 20 to be issued, and the mathematical formula corresponding to each of the chip cards 20 and the initial code corresponding to the mathematical formula are created in a backend system 11; upon implementation, the backend system 11 can be a network information management computing system created by an issuing institution.

(b) creating personal information of a cardholder, wherein when each of the chip cards 20 is to be issued, a management platform 12 respectively sends the personal information from an account of the cardholder of the chip card 20 to be issued back to the backend system 11 for authentication, where the backend system 11 respectively determines a corresponding relationship between information stored in the chip card 20 to be issued by the management platform 12 and the personal information of the cardholder; upon implementation, the management platform 12 can be a network information management computing system created by an issuing bank.

(c) generating a dynamic source and a dynamic identification code, when the issued and activated chip card 20 is to make a transaction, a chip card reading device 30 is used to correspondingly generate a time of the transaction, and the chip card 20 uses at least an accumulated number of transactions and the time of the transaction as the dynamic source for plugging into a mathematical formula thereof and generating a set of dynamic identification code; upon implementation, the chip card reading device 30 can be a chip card reader.

(d) requesting for authorization, the chip card reading device 30 transmits at least the dynamic source generated from the transaction and the dynamic identification code to the management platform 12; upon implementation, the chip card reading device 30 can transmit at least the dynamic source generated from the transaction and the dynamic identification code to the management platform 12 over closed networks or open networks.

(e) generating dynamic verification information, wherein the management platform 12 transmits at least a card number of the chip card 20 and the dynamic source generated from the transaction to the backend system 11, such that the backend system 11 can plug the obtained dynamic source into the mathematical formula corresponding to the card number of the chip card 20 and subsequently generating a set of dynamic verification code; upon implementation, the management platform 12 can also transmit at least the card number of the chip card 20 and the dynamic source generated from the transaction to the backend system 11 over closed networks or open networks.

(f) obtaining authorization, wherein the backend system 11 transmits the dynamic verification code back to the management platform 12, and then the management platform 12 compares the received dynamic verification code with the dynamic identification code, and authorizing the transaction if they match, or rejecting the transaction if not; similarly, the backend system 11 can also transmit the dynamic verification code back to the management platform 12 over closed networks or open networks.

In principle, when a chip card according to the method for verifying transactions in chip cards of the present invention is used to make a transaction, a dynamic source generated from the transaction and a dynamic verification code are used as a basis for requesting authorization. Since only the card number of the chip card included in the transmitted information is static information while the remaining is dynamic information, and the backend system 11 is used to transmit the dynamic verification code in a single direction to the management platform 12 for performing comparison and obtaining verification for the authorization, personal information of a particular account and data stored in a chip card thereof cannot be obtained by intercepting the transmitted transactional details, effectively protecting the chip card from being copied, and facilitating transmission of transactional messages or transactional information over open networks.

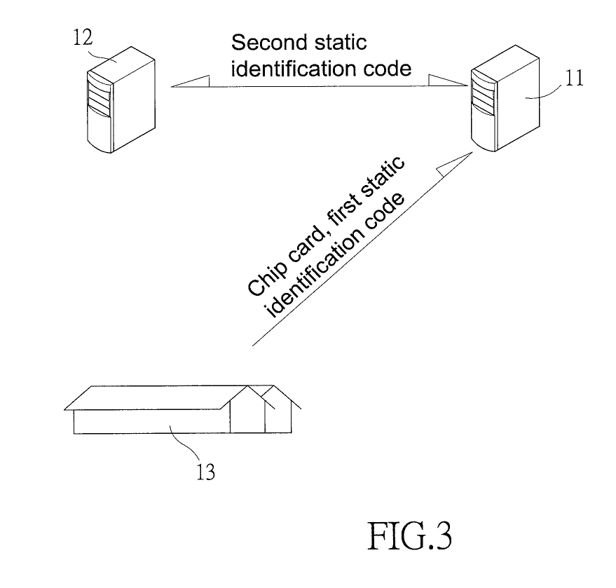

Referring to FIG. 3, upon implementing the method for verifying transactions in chip cards according to the present invention, the step of creating a mathematical formula and an initial code can further comprise having the chip card manufacturing factory 13 providing a plurality of first static identification codes for the backend system 11 to respectively identify stored information between each of the chip cards 20, and the setting of the first static identification codes can prevent staff at a chip card manufacturing factory from decoding account information of a specific chip corresponding to a backend system (an issuing institution) and making counterfeit cards on a large scale.

In addition, upon implementing the method for verifying transactions in chip cards according to the present invention, the step of creating personal information of a cardholder can further comprise having the backend system 11 generating a plurality of second static identification codes for respectively identifying identities of each of the chips 20 by the backend system 11 and by the management platform 12, and by setting the second static identification codes, staff at a management platform (an issuing bank) is prevented from decoding account information of a specific chip corresponding to a backend system (an issuing institution) and making counterfeit cards on a large scale.

Surely, upon implementing the method for verifying transactions in chip cards according to the present invention, the step of creating a mathematical formula and an initial code further comprises having the chip card manufacturing factory 13 providing a plurality of first static identification codes for the backend system 11 to respectively identify stored information between each of the chip cards 20; the step of creating personal information of a cardholder further comprises having the backend system 11 generating a plurality of second static identification codes for respectively identifying identities of each of the chips 20 by the backend system 11 and the management platform 12, and said manners of implementation are preferable.

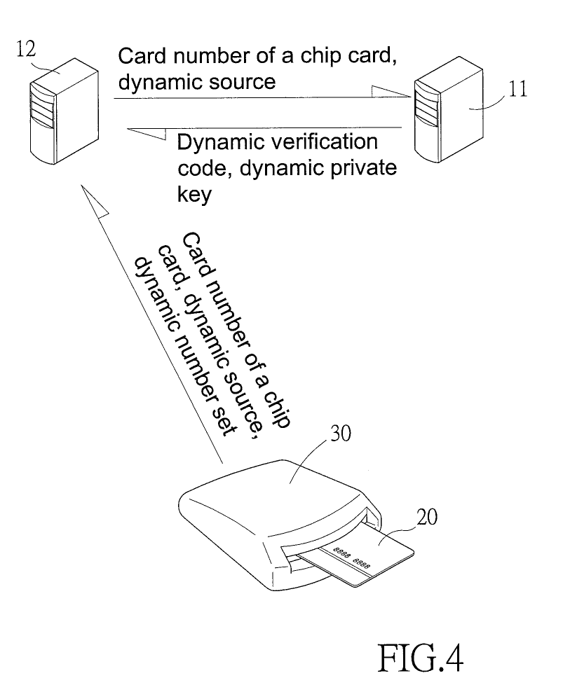

Referring to FIGS. 1, 3 and 4, in the method for verifying transactions in chip cards according to the present invention, the step of creating a mathematical formula and an initial code can further comprise respectively integrating at least one mathematical ciphertext into the chip card 20 to be issued. The step of generating a dynamic source and a dynamic identification code further comprises generating a dynamic ciphertext from the mathematical ciphertext and the dynamic source generated from the transaction, and then integrating the dynamic ciphertext with information randomly inputted by the cardholder in the transaction into a dynamic number set.

The step of requesting for authorization further comprises the chip card reading device 30 transmits at least the dynamic number set generated from the transaction to the management platform 12, and the step of generating dynamic verification information further comprises the backend system 11 generating a set of dynamic private key from the obtained dynamic source and the mathematical ciphertext corresponding to the card number of the chip card 20. The step of obtaining authorization further comprises the backend system 11 transmitting the dynamic private key back to the management platform 12, such that the management platform 12 can use the dynamic private key to decrypt the dynamic number set, and recover the information randomly inputted by the cardholder in the transaction if the dynamic private key matches with the dynamic ciphertext. Accordingly, the method for verifying transactions in chip cards of the present invention can be used in verifying authorization of an e-commerce transaction process in a chip card, and widely applied in encrypted transmission of network information.

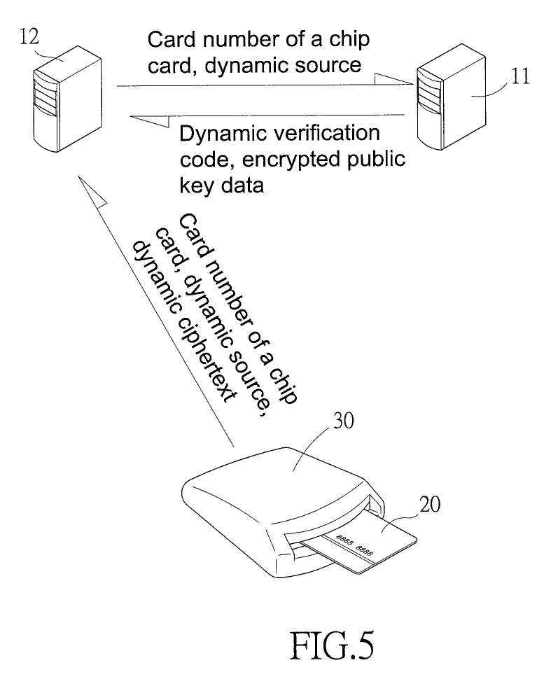

Referring to FIGS. 1, 3 and 5, in the method for verifying transactions in chip cards according to the present invention, the step of creating a mathematical formula and an initial code can further comprise respectively integrating at least two sets of hidden passing phrase into the chip card 20 to be issued. The step of generating a dynamic source and a dynamic identification code further comprises generating a dynamic second-track encryption initial code from the hidden passing phrases, the dynamic source generated from the transaction and the personal information stored in the chip card 20, and generating a dynamic identification code and multiple sets of dynamic ciphertext from the dynamic second-track encryption initial code, the personal information stored in the chip card 20 and random transactional information randomly inputted in the transaction by computation through using the two sets of hidden passing phrase.

The step of requesting for authorization further comprises the chip card reading device 30 transmitting the card number of the chip card 20, the dynamic source, the dynamic identification code and the multiple sets of dynamic ciphertext to the management platform 12; the step of generating dynamic verification information further comprises the management platform 12 transmitting at least the card number of the chip card 20, the dynamic source and the dynamic identification code to the backend system 11, such that the backend system 11 can plug the dynamic source into the mathematical formula corresponding to the card number of the chip card 20, the initial code and any of the hidden passing phrases for generating a dynamic ciphertext decryption public key, and the backend system 11 is set to further encrypt the dynamic ciphertext decryption public key into encrypted public key data by using private key data of the management platform 12 if the dynamic ciphertext decryption public key matches with the dynamic identification code, and then transmit the encrypted public key data to the management platform 12.

The step of obtaining authorization further comprises the management platform 12 recovering the dynamic second-track encryption initial code by further using the private key data thereof to decrypt the encrypted public key data, and then authorizing the transaction if the random transactional information and personal information (the correct original text) is obtained after decrypting by utilizing the dynamic ciphertext, or rejecting the transaction if not.

Similar to setting a different PIN (Personal Identification Number) number for each chip card, the hidden passing phrases are set differently for each chip card, and a set of PIN number can be randomly inputted each time for generating a different dynamic track each time; for instance, assuming the hidden passing phrase is set as 123 and the number 345 (can be made public) is randomly inputted, then the dynamic index for this time is 468, which is used to generate random dynamism and multiple dynamic mathematical tracks.

The dynamic second-track encryption initial code is generated from the initial code, the hidden passing phrases, the mathematical formula and the dynamic source, and then used to perform computation through employing two sets or more hidden passing phrases in order to generate a dynamic identification code and multiple sets of dynamic ciphertext; the presence of multiple sets of passing phrase can be used to generate multiple sets of computation and then combined into a dynamic identification code and multiple sets of dynamic ciphertext, and the described computations can counter the risk of decoding. Therefore, personal information of a particular account and data stored in a chip card thereof cannot be obtained by intercepting the transmitted transactional details, effectively protecting the chip card from being copied, and facilitating the transmission of transactional messages or transactional information over open networks.

In addition to the aforesaid possible embodiments, the method for verifying transactions in chip cards of the present invention can also have the step of creating a mathematical formula and an initial code further comprised of having the chip card manufacturing factory 13 providing a plurality of first static identification codes for the backend system 11 to respectively identify stored information between each of the chip cards 20, and the setting of the first static identification codes can prevent staff at a chip card manufacturing factory from decoding account information of a specific chip corresponding to a backend system (an issuing institution) and making counterfeit cards on a large scale.

In addition, the step of creating personal information of a cardholder can further comprise having the backend system 11 generating a plurality of second static identification codes for respectively identifying identities of each of the chip cards 20 by the backend system 11 and by the management platform 12, and by setting the second static identification codes, staff at a management platform (an issuing bank) is prevented from decoding account information of a specific chip corresponding to a backend system (an issuing institution) and making counterfeit cards on a large scale.

Surely, the step of creating a mathematical formula and an initial code further comprises having the chip card manufacturing factory 13 providing a plurality of first static identification codes for the backend system 11 to respectively identify stored information between each of the chip cards 20; the step of creating personal information of a cardholder further comprises having the backend system 11 generating a plurality of second static identification codes for respectively identifying identities of each of the chip cards 20 by the backend system 11 and the management platform 12, and said manners of implementation are preferable.

In comparison with the prior art, the method for verifying transactions in chip cards disclosed in the present invention uses a dynamic source generated from a current transaction and a dynamic verification code as a basis for requesting authorization, and obtains verification for the authorization by using the backend system to perform comparison in a single direction, thus preventing personal information of a particular account and data stored in a chip card thereof from being obtained by intercepting the transmitted transactional content, and effectively protecting the chip card from being copied, facilitating the transmission of transactional messages or transactional information over open networks. The method can even be widely applied in encrypted transmission of network information; by setting the first and the second static identification codes, a management platform (an issuing bank) or staff at a chip card manufacturing factory can be prevented from decoding account information of a specific chip corresponding to a backend system (an issuing institution) and making counterfeit cards on a large scale.

It is of course to be understood that the embodiments described herein is merely illustrative of the principles of the invention and that a wide variety of modifications thereto may be effected by persons skilled in the art without departing from the spirit and scope of the invention as set forth in the following claims.

1. A method for verifying transactions in chip cards, the method comprising steps of:
a) creating a mathematical formula and an initial code, wherein a chip card manufacturing factory respectively integrates at least the mathematical formula and the initial code corresponding to the mathematical formula into a chip card to be issued, and the mathematical formula corresponding to each of the chip cards and the initial code corresponding to the mathematical formula are created in a backend system;
b) creating personal information of a cardholder, wherein when each of the chip cards is to be issued, a management platform respectively sends personal information from an account of the cardholder of the chip card to be issued back to the backend system for authentication, where the backend system respectively determines a corresponding relationship between information stored in the chip card to be issued by the management platform and the personal information of the cardholder;
c) generating a dynamic source and a dynamic identification code, as the issued and activated chip card is to make a transaction, a chip card reading device is used to correspondingly generate a time of the transaction, and the chip card uses at least an accumulated number of transactions and the time of the transaction as the dynamic source for plugging into a mathematical formula thereof and generating a set of dynamic identification code;
d) requesting for authorization, the chip card reading device transmits at least the dynamic source generated from the transaction and the dynamic identification code to the management platform;
e) generating dynamic verification information, wherein the management platform transmits at least a card number of the chip card and the dynamic source generated from the transaction to the backend system, wherein the backend system plugs the obtained dynamic source into the mathematical formula corresponding to the card number of the chip card and subsequently generating a set of dynamic verification code;
f) obtaining authorization, wherein the backend system transmits the dynamic verification code back to the management platform, and then the management platform compares the received dynamic verification code with the dynamic identification code, and authorizing the transaction if the dynamic verification code matches with the dynamic identification code, or rejecting the transaction if not.

2. The method for verifying transactions in chip cards of claim 1, wherein the step of creating a mathematical formula and an initial code further includes respectively integrating at least one mathematical ciphertext into the chip card to be issued; the step of generating a dynamic source and a dynamic identification code further comprises generating a dynamic ciphertext from the mathematical ciphertext and the dynamic source generated from the transaction, and then generating a dynamic number set by integrating the dynamic ciphertext with information randomly inputted by the cardholder in the transaction; the step of requesting for authorization further includes the chip card reading device transmitting at least the dynamic number set generated from the transaction to the management platform; the step of generating dynamic verification information further includes the backend system generating a set of dynamic private key by using the obtained dynamic source and the mathematical ciphertext corresponding to the card number of the chip card; the step of obtaining authorization further includes the backend system transmitting the dynamic private key back to the management platform, wherein the management platform using the dynamic private key to decrypt the dynamic number set, and recover the information randomly inputted by the cardholder in the transaction if the dynamic private key matches with the dynamic ciphertext.

3. The method for verifying transactions in chip cards of claim 1, wherein the step of creating a mathematical formula and an initial code further includes respectively integrating at least two sets of hidden passing phrase into the chip card to be issued; the step of generating a dynamic source and a dynamic identification code further includes generating a dynamic second-track encryption initial code from the hidden passing phrases, the dynamic source generated from the transaction and the personal information stored in the chip card, and generating a dynamic identification code and multiple sets of dynamic ciphertext from the dynamic second-track encryption initial code, the personal information stored in the chip card and random transactional information randomly inputted in the transaction by computation through using the two sets of hidden passing phrase; the step of requesting for authorization further includes the chip card reading device transmitting the card number of the chip card, the dynamic source, the dynamic identification code and the multiple sets of dynamic ciphertext to the management platform; the step of generating dynamic verification information further includes the management platform transmitting at least the card number of the chip card, the dynamic source and the dynamic identification code to the backend system, wherein the backend system plugs the dynamic source into the mathematical formula corresponding to the card number of the chip card, the initial code and any of the hidden passing phrases for generating a dynamic ciphertext decryption public key, and the backend system is set to further encrypt the dynamic ciphertext decryption public key into encrypted public key data by using private key data of the management platform if the dynamic ciphertext decryption public key matches with the dynamic identification code, and then transmit the encrypted public key data to the management platform; the step of obtaining authorization further includes the management platform recovering the dynamic second-track encryption initial code by further using the private key data thereof to decrypt the encrypted public key data, and then authorizing the transaction if the random transactional information and personal information is obtained after decrypting by utilizing the dynamic ciphertext, or rejecting the transaction if not.

4. The method for verifying transactions in chip cards of claim 1, wherein the step of creating a mathematical formula and an initial code further includes having a chip card manufacturing factory providing a plurality of first static identification codes for the backend system to respectively identify stored information between each of the chip cards.

5. The method for verifying transactions in chip cards of claim 2, wherein the step of creating a mathematical formula and an initial code further includes having a chip card manufacturing factory providing a plurality of first static identification codes for the backend system to respectively identify stored information between each of the chip cards.

6. The method for verifying transactions in chip cards of claim 3, wherein the step of creating a mathematical formula and an initial code further includes having a chip card manufacturing factory providing a plurality of first static identification codes for the backend system to respectively identify stored information between each of the chip cards.

7. The method for verifying transactions in chip cards of claim 1, wherein the step of creating personal information of a cardholder further includes having the backend system generating a plurality of second static identification codes for respectively identifying identities of each of the chip cards by the backend system and the management platform.

8. The method for verifying transactions in chip cards of claim 2, wherein the step of creating personal information of a cardholder further includes having the backend system generating a plurality of second static identification codes for respectively identifying identities of each of the chip cards by the backend system and the management platform.

9. The method for verifying transactions in chip cards of claim 3, wherein the step of creating personal information of a cardholder further includes having the backend system generating a plurality of second static identification codes for respectively identifying identities of each of the chip cards by the backend system and the management platform.

10. The method for verifying transactions in chip cards of claim 1, wherein the step of creating a mathematical formula and an initial code further includes having a chip card manufacturing factory providing a plurality of first static identification codes for the backend system to respectively identify stored information between each of the chip cards; and, the step of creating personal information of a cardholder further includes having the backend system generating a plurality of second static identification codes for respectively identifying identities of each of the chip cards by the backend system and the management platform.

11. The method for verifying transactions in chip cards of claim 2, wherein the step of creating a mathematical formula and an initial code further includes having a chip card manufacturing factory providing a plurality of first static identification codes for the backend system to respectively identify stored information between each of the chip cards; and, the step of creating personal information of a cardholder further includes having the backend system generating a plurality of second static identification codes for respectively identifying identities of each of the chip cards by the backend system and the management platform.

12. The method for verifying transactions in chip cards of claim 3, wherein the step of creating a mathematical formula and an initial code further includes having a chip card manufacturing factory providing a plurality of first static identification codes for the backend system to respectively identify stored information between each of the chip cards; and, the step of creating personal information of a cardholder further includes having the backend system generating a plurality of second static identification codes for respectively identifying identities of each of the chip cards by the backend system and the management platform.

13. The method for verifying transactions in chip cards of claim 1, wherein the backend system is a network information management computing system created by an issuing institution, and the management platform is a network information management computing system created by an issuing bank.

14. The method for verifying transactions in chip cards of claim 2, wherein the backend system is a network information management computing system created by an issuing institution, and the management platform is a network information management computing system created by an issuing bank.

15. The method for verifying transactions in chip cards of claim 3, wherein the backend system is a network information management computing system created by an issuing institution, and the management platform is a network information management computing system created by an issuing bank.
